(19) United States
(12) Patent Application Publication
(10) Pub. No.: US 2008/0084978 A1
(43) Pub. Date: Apr. 10, 2008

(54) METHODS AND SYSTEM FOR TRANSMITTING AN ALTERNATE CALLER IDENTIFICATION NUMBER

(75) Inventors: Prema Venkatesulu, Yardley, PA (US); Louis D. Bifano, Morrisville, PA (US); Thomas F. Kister, Chalfont, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/548,161

(22) Filed: Oct. 10, 2006

(51) Int. Cl. H04M 15/06

(52) U.S. Cl. 379/142.01

(57) ABSTRACT

A method for receiving a caller identification (ID) number on an electronic device in a communication network (100) is provided. The communication network includes a plurality of electronic devices (104 and 106) and a plurality of network elements (102). The method includes receiving a signal from a first electronic device. The first electronic device has a primary caller ID number and at least one alternate caller ID number. The method also includes sending the alternate caller ID number to a second electronic device, based on the signal received from the first electronic device.

### FIELD OF THE INVENTION

This invention relates generally to managing calls in a communication network, and more particularly, to a method and system for transmitting an alternate caller identification number in the communication network during a call.

### BACKGROUND OF THE INVENTION

With an enhanced need for communication and information exchange, the use of communication networks has also increased. There are different types of communication networks, for example, wireless communication networks and wired communication networks. Examples of wireless communication networks include a Global System for Mobile Communication (GSM) network, a Time Division Multiple Access (TDMA) communication network, a Code Division Multiple Access (CDMA) communication network, and the like. An example of a wired communication network is a public-switched telephone network (PSTN). A communication network includes one or more service providers and one or more communication devices. Examples of communication devices include, but are not limited to, landline telephones, mobile telephones, PDAs, laptops, and other similar devices with a communication interface. Currently, a growing number of services such as call forwarding, call waiting, conferencing, and caller identification have become available to users of communication devices.

The caller identification (ID) service is mainly used by users of the communication devices to identify the caller in an in-coming call. Caller identities provided by the caller ID service help users to screen calls, so that they can only respond to important in-coming calls. In addition, the caller ID service enables a user to see the caller ID number of the communication device from which he/she has received a call, and thereafter call back at that number, even if he/she failed to attend the phone call or when no voice message was left.

A caller ID device can be a stand-alone hardware device or software implemented as an integral part of the communication device. Typically, the communication network provides the caller ID service to the communication device or hardware device associated with the communication device. The hardware device attached to the communication device is specifically designed to record and display the caller ID information.

In accordance with a known technique, when a first communication device calls a second communication device in the communication network, the caller ID number of the first communication device is displayed on the second communication device. However, if there is no response from the second communication device, a ‘missed call’, along with the caller ID number of the first communication device, is displayed on the display screen of the second communication device. Later, the first communication device can receive a call from the second communication device in response to the missed call.

There may be a case when the user of the first communication device specifically wants to receive a call on a third communication device. This may be because of the economical call rates plan associated with the third communication device. In this case, the user may wish to avoid receiving the call on the first communication device. For example, if a service provider of the first communication device charges higher cell phone minutes then the third communication device for receiving a call, the user of the first communication device may like to receive calls on the third communication device for cheaper communication. In addition, there may also be a case when the battery of the first communication device is discharged or the first communication device is present in an area where network coverage and signal reception are not sufficient. As a result, the communication link with the first communication device may not be established. This may have fatal consequences, especially in the event of an emergency.

In view of the foregoing discussion, there exists a need for a method and system that can provide flexibility to a user to receive an incoming call on a preferred alternate communication device.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary communication network, in accordance with an embodiment of the present invention;

FIG. 2 illustrates a block diagram of a network element, in accordance with an embodiment of the present invention; and

FIG. 3 is a flow diagram illustrating a method for receiving a caller identification number, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of embodiments of the present invention.

### DETAILED DESCRIPTION

Before describing in detail the particular method and system for receiving a caller identification (ID) number on an electronic device in a communication network, in accordance with various embodiments of the present invention, it should be observed that the present invention resides primarily in combinations of method steps and apparatus components related to the method and system for receiving a caller identification (ID) number on an electronic device in a communication network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as first and second, and the like, may be used solely to distinguish one entity or action from another entity or action, without necessarily requiring or implying any actual relationship or order between such entities or actions. The terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

In an embodiment, a method for receiving a caller identification (ID) number on an electronic device in a communication network is provided. The communication network includes a plurality of electronic devices and a plurality of network elements. The method includes receiving a signal from a first electronic device. The first electronic device has a primary caller ID number and at least one alternate caller ID number. The method also includes sending at least one of the alternate caller ID numbers to a second electronic device, based on the signal received from the first electronic device.

In another embodiment, a network element is provided. The network element includes a transceiver and a processor. The transceiver receives a signal from a first electronic device, which has a primary caller identification (ID) number and at least one alternate caller ID number. The processor is operatively coupled with the transceiver. Further, the processor is capable of selecting at least one of the alternate caller ID numbers, based on the signal received from the first electronic device.

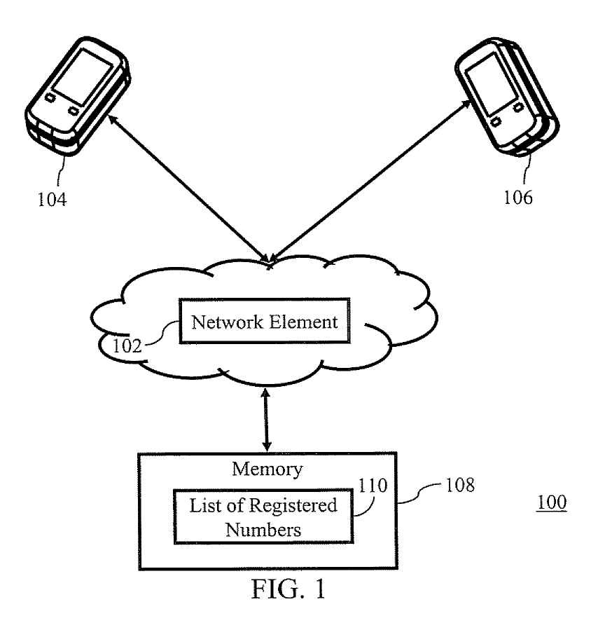

FIG. 1 illustrates an exemplary communication network 100, in accordance with an embodiment of the present invention. The communication network 100 includes a network element 102 and a plurality of electronic devices such as electronic devices 104 and 106. Although only the electronic devices 104 and 106 have been shown, it will be apparent to a person ordinarily skilled in the art that the communication network 100 can include more electronic devices. Examples of the communication network 100 include, but are not limited to, a Code Division Multiple Access (CDMA) network, a Universal Mobile Telecommunications System (UMTS) network, a Global System for Mobile Communication (GSM) network, and a Time Division Multiple Access (TDMA) network. Examples of the network element 102 can include a Base Transceiver Station (BTS), a server, a computing device, and the like. Examples of the electronic devices 104 and 106 include, but are not limited to, fixed and mobile telephones, palmtops, laptops, and video phones.

The network element 102 enables communication between the plurality of electronic devices in the communication network 100. For example, the network element 102 may enable communication between the electronic device 104 and the electronic device 106. In an embodiment, the network element 102 is associated with a service provider. The service provider provides services to the mobile phones subscribed with it. When a communication link is established between the electronic devices 104 and 106, the caller ID number of the electronic device 104 is displayed on the display screen of the electronic device 106. Thereby, a user of the electronic device 106 knows that the call has originated from the electronic device 104 before attending the call.

The network element 102 is operatively coupled with a memory 108. In an embodiment, the memory 108 may not be located on the network element 102 and may be located on an external device, communicating remotely with the network element 102. The memory 108 maintains information about the electronic devices associated with the network element 102. In an embodiment, the memory 108 stores a list of registered numbers 110 corresponding to each of the plurality of electronic devices associated with the network element 102.

Each of the electronic devices in the communication network 100 is assigned a unique primary caller ID number. For example, the electronic device 104 has a primary caller ID number, which is a unique number assigned to the electronic device 104 in the communication network 100. In an embodiment, the primary caller ID number of an electronic device is a phone number or contact number of the user of the electronic device. In addition to the primary caller ID number, the electronic device may also be associated with at least one alternate caller ID number. Examples of the alternate caller ID number include a residential landline phone number, an alternative mobile phone number, and so forth. The alternate caller ID number(s), along with the primary caller ID number, constitutes the list of registered numbers for the electronic device.

In an embodiment the list of registered numbers are stored in the electronic device 104. Further, when a user of the electronic device 104 communicates with the electronic device 106 and selects the alternate caller ID number to be sent. The electronic device 104 verifies the alternate caller ID number with the list of registered numbers stored at the electronic device 104. The alternate caller ID number is sent to the network element 102, if the alternate caller ID number is verified. But, if the alternate caller ID number is not verified, the primary caller ID number of the electronic device 104 is sent to the network element 102.

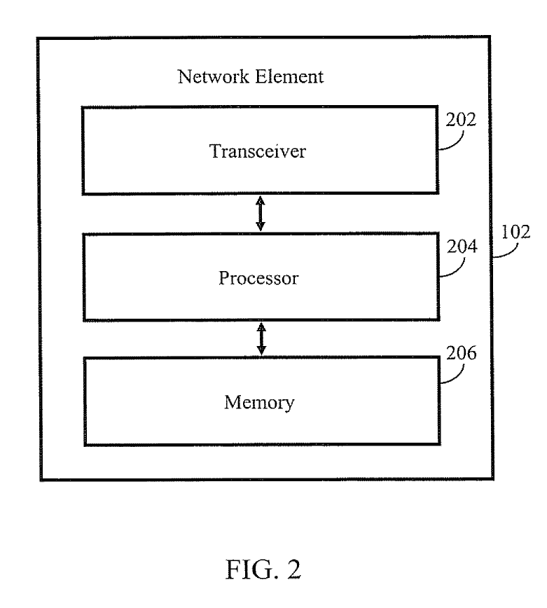

FIG. 2 illustrates a block diagram of the network element 102, in accordance with an embodiment of the present invention. The network element 102 includes a transceiver 202 and a processor 204. The network element 102 supports communication between a plurality of electronic devices in a communication network, for example, between the electronic devices 104 and 106 in the communication network 100. The transceiver 202 of the network element 102 receives signals from the electronic devices in the communication network 100. For example, when the electronic device 104 communicates with the electronic devices 106 in the communication network 100, the electronic device 104 sends a signal to the network element 102 to initiate communication with the electronic device 106. In an embodiment, the signal includes an alternate caller ID number to send the same to the electronic device 106. In another embodiment, the signal includes a message requesting the network element 102 to send an alternate caller ID number to the electronic device 106.

The processor 204 is operatively coupled with the transceiver 202. Based on the signal received by the transceiver 202 from the electronic device 104, the processor 204 selects the alternate caller ID number. The transceiver 202 sends the alternate caller ID number to the electronic device 106. In an embodiment, the network element 102 includes a memory 206. The memory 206 maintains the list of registered numbers associated with each of the plurality of electronic devices. In an embodiment, the list of registered numbers may be provided and/or updated by a user of the electronic device 104 while or after subscribing to the services of the network element 102. For example, when the user of the electronic device 104 registers for the services of the network element 102, he/she may provide a list of numbers to the network element 102. The user of the electronic device 104 may periodically update the list of registered numbers of the electronic device 104, for example, every month or fortnight.

In an embodiment, the processor 204 verifies the alternate caller ID number with the list of registered numbers maintained by the memory 206. Further, when the alternate caller ID number is verified by the processor 204, the alternate caller ID number is transmitted by the transceiver 202 to the electronic device 106. In another embodiment, when the alternate caller ID number is not verified by the processor 204, the primary caller ID number of the electronic device 104 is transmitted by the transceiver 202 to the electronic device 104. For example, the electronic device 104, while establishing a communication link with the electronic device 106, can send the alternate caller ID to the network element 102, to be displayed on the electronic device 106 as the caller ID number. The network element 102 may then verify the alternate caller ID with the list of registered numbers stored in the memory 206. The list of registered numbers may have been provided by the user of the electronic device 104 at the time of registration with the service provider. The alternate caller ID number is sent to the network element 102 when it is present in the list of registered numbers; otherwise the primary caller ID number is sent to the electronic device 106.

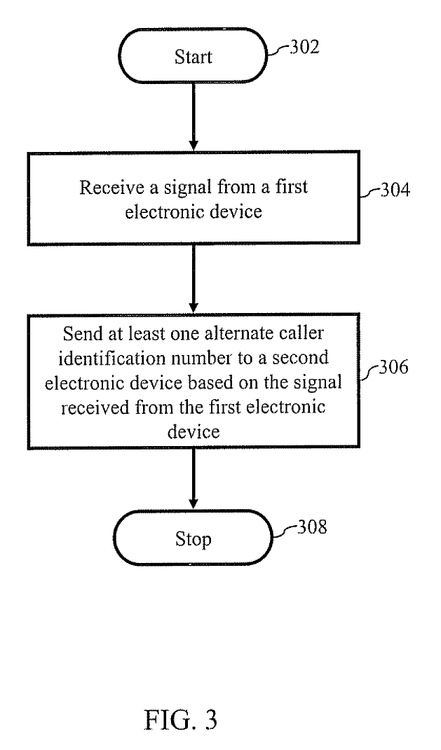

FIG. 3 is a flow diagram illustrating a method for receiving a caller identification number, in accordance with an embodiment of the present invention. The method shows the different steps involved in receiving the caller identification (ID) number. Moreover, the method can comprise fewer or greater number of steps than that shown in FIG. 3. To describe the flow diagram, reference will be made to FIG. 1 and FIG. 2, although it will be understood by a person ordinarily skilled in the art that the flow diagram can be implemented with reference to any other suitable embodiment of the present invention.

The method is initiated at step 302. At step 304, the transceiver 202 in the network element 102 receives a signal from the electronic device 104 to establish a communication link with the electronic device 106. The electronic device 104 has a primary caller ID number that is a unique identification number for the electronic device 104. In addition to the primary caller ID number, the electronic device 104 can also have an alternate caller ID number. The alternate caller ID number is an alternate number associated with the electronic device 104, which the user of the electronic device 104 desires to display while communicating with the electronic device 106. In an embodiment, the signal received by the transceiver 202 to send the alternate caller ID number to the electronic devices 106 includes an alternate caller ID number. In another embodiment, the signal includes the alternate caller ID number and the primary caller ID number of the electronic device 104. In yet another embodiment, the signal includes a message requesting the network element 102 to send the alternate caller ID number associated with the electronic device 104 to the electronic device 106. At step 306, the transceiver 202 sends the alternate caller ID number to the electronic device 106.

After receiving the signal from the electronic device 104 at the transceiver 202, the processor 204, which is operatively coupled to the transceiver 202, verifies the alternate caller ID number with the list of registered numbers stored in the memory 206. In an embodiment, the processor 204 first selects the alternate caller ID that is to be sent to the electronic device 106 when the alternate caller ID number is present in the list of registered numbers. The transceiver 202 then sends the alternate caller ID number to the electronic device 106. In another embodiment, the primary caller ID number is sent by the transceiver 202, in place of the alternate caller ID number, when the alternate caller ID is not present in the list of registered numbers. The caller ID number sent by the transceiver 202 is displayed on the electronic device 106.

For example, a user of the electronic device 104 initially registers for the services of the network element 102. At the time of registration, the user can provide a list of numbers to the network element 102. As per his/her needs, the user of the electronic device 104 may wish to display the alternate caller ID number on the electronic device 106 while communicating with the electronic device 106. To display the alternate caller ID number, the electronic device 104 can send a message/alternate caller ID number to the network element 102 when the alternate caller ID number is present in the list of registered numbers. However, when the alternate caller ID number is not present in the list of registered numbers, the primary caller ID number of the electronic device 104 is sent to the electronic device 106. The caller ID number is then displayed on the electronic device 106.

In an embodiment, the method can be implemented in a computer-readable storage element with a computer-readable code stored thereon to program a computer to perform the method. Thereafter, the method terminates at step 308.

Various embodiments, as described above, provide a method and system for receiving a caller identification (ID) number on an electronic device in a communication network. A user of an electronic device can send an alternate caller ID number to other electronic devices in the communication network, displaying the alternate caller ID number on the other electronic devices while communicating. This may be used when the user wants to receive a call on the alternate electronic device because of the cheaper call rates plan at the alternate electronic device. For example, if the electronic device is a mobile phone and the alternate electronic device is a landline phone, the mobile phone may charge higher cell phone minutes for receiving a call compared to the landline phone. Thus, receiving the call on the landline phone will be cost efficient. Further, sending the alternate caller ID number would enable the user to communicate through an alternate electronic device in the event of a battery getting discharged or while encountering problems pertaining to weaker signal reception.

The invention disclosed herein would be especially useful in case of an emergency. For example, if a fire breaks out at a specific location, such as an office, a user may send the office phone number as an alternate caller ID number to the emergency services, like 911. This may be the case when there is network congestion and the out-going calls from the phone are not possible. Thereafter, the emergency services can reach the location of the office, by tracing the address of the office phone number location.

It will be appreciated that the method and system for transmitting a caller identification number in a communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. Therefore, these functions may be interpreted as steps of a method that enables users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for receiving a caller identification (ID) number on an electronic device in a communication network, the communication network comprising a plurality of electronic devices and a plurality of network elements, the method comprising:
receiving a signal from a first electronic device, the first electronic device having a primary caller ID number and at least one alternate caller ID number associated therewith; and
sending at least one of the alternate caller ID numbers to a second electronic device based on the signal received from the first electronic device.

2. The method as recited in claim 1, wherein receiving the signal comprises receiving the at least one alternate caller ID number.

3. The method as recited in claim 1, wherein receiving the signal comprises receiving at least one alternate caller ID number and the primary caller ID number.

4. The method as recited in claim 1, wherein receiving the signal comprises receiving a message for enabling reception of at least one alternate caller ID number.

5. The method as recited in claim 1, wherein at least one of the alternate caller ID numbers is displayed upon the second electronic device based on the signal received from the first electronic device.

6. The method as recited in claim 1 further comprising verifying at least one alternate caller ID number from a list of registered numbers, wherein the list of registered numbers is associated with a user of the first electronic device.

7. The method as recited in claim 6 further comprising sending at least one verified alternate caller ID number to the second electronic device when the at least one verified alternate caller ID number is present in the list of registered numbers.

8. The method as recited in claim 6 further comprising sending the primary caller ID number in place of the at least one alternate caller ID number to the second electronic device when the at least one alternate caller ID number is not present in the list of registered numbers.

9. A network element comprising:
a transceiver capable of receiving a signal from a first electronic device, the first electronic device having a primary caller identification (ID) number and at least one alternate caller ID number associated therewith; and
a processor operatively coupled with the transceiver, wherein the processor is capable of selecting at least one of the alternate caller ID numbers based on the signal received from the first electronic device.

10. The network element as recited in claim 9, wherein the signal comprises the at least one alternate caller ID number.

11. The network element as recited in claim 9, wherein the signal comprises a message for enabling reception of the at least one alternate caller ID number.

12. The network element as recited in claim 9, wherein the processor is further capable of verifying the at least one alternate caller ID number from a list of registered numbers.

13. The network element as recited in claim 12, wherein the network element comprises a memory for managing the list of registered numbers.

14. The network element as recited in claim 9, wherein the transceiver is further capable of sending the at least one alternate caller ID number to a second electronic device, wherein the at least one alternate caller ID number sent to the second electronic device is selected by the processor.
